(19) United States
(12) Patent Application Publication
(10) Pub. No.: US 2013/0318429 A1
(43) Pub. Date: Nov. 28, 2013

(54) DYNAMIC FLOATING WEB VIDEO PLAYER

(71) Applicant: MOVILE, Sao Paulo (BR)

(72) Inventors: Marcio H. Dantas, Campinas (BR); Flavio F. Stecca, Campinas (BR)

(73) Assignee: MOVILE, Sao Paulo (BR)

(21) Appl. No.: 13/654,185

(22) Filed: Oct. 17, 2012

Related U.S. Application Data
(60) Provisional application No. 61/650,428, filed on May 22, 2012.

(51) Int. Cl. G06F 3/048

(52) U.S. Cl. CPC G06F 3/048
USPC 715/234

(57) ABSTRACT

The Dynamic Floating Video Player is a piece of software that floats above all other application windows. It's possible to browse the web and access other web pages, open other applications change the current window, etc. and the Dynamic Floating Video Player remains open and visible.

### CROSS REFERENCE TO RELATED APPLICATIONS

This application claims the benefit of priority of U.S. Provisional Patent Application Ser. No. 61/650,428, entitled DYNAMIC FLOATING WEB VIDEO PLAYER filed on May 22, 2012, hereby incorporated by reference in its entirety.

### BACKGROUND OF THE DISCLOSURE

Watching videos via the Internet (web) on a computer or Internet coupled television is now an everyday activity. There are millions of videos on websites like YouTube, Facebook, blogs, institutional company websites, educational websites, etc. Users interact with video on the web

The majority of websites have adopted an embedded video player solution such as is described in United States Patent Publication No. 2009/0024923. Basically it is possible to see the video inside the current web page when the user clicks within the page to play the video. The video player applet expands inside the current page and starts to play.

Today there is no webpage that allows you to watch the video and browse other pages or use other programs at the same time. The problem is windows focus. Normally the web pages use the embedded player concept or open the video in other webpage (other tab) and the user has to alternate between the windows/screens to watch the video. For example, if you start a video on YouTube, and alternate the window to outlook, the YouTube video keeps running, we can listen the audio but you can't see the video because the screen focused in on outlook—you have to alternate to your browser again to continue watching the video.

### SUMMARY OF THE DISCLOSURE

The Dynamic Floating Video Player is an applet, i.e. a piece of software that produces a video player window that floats above all other application windows. It's possible to browse the web and access other web pages, open other applications change the current window, etc. and the Dynamic Floating Video Player remains open and visible.

It's a great experience for the users that can share their attention between the video and other activities like listening to music while surfing the web. Today most users are constantly multitasking. They perform a lot of tasks simultaneously such as; listening to music, replying to email, chatting with friends, reading news and browsing on Facebook. It is common for a user to perform all of these tasks within the same timeframe and alternating between numerous windows/screens. This applet allows the user watch a video, started on a webpage while performing other tasks without the need to view the video within a fixed browser window. Typically the Dynamic Floating Video Player in accordance with this disclosure will also run above, i.e., in front of or on top of any user's software such as a common email client's software.

Some embodiments of the present invention are summarized in this section. One exemplary embodiment is computer-implemented method that comprises providing a computing device connected to a network, the device having a processor, a memory connected to the processor, and a computer display screen, embedding a first software module in a web page capable of displayed on the screen by a web browser operating in the computing device, embedding a second module in a popup video player application running in a different application from the web browser, and sending a message between the first and second modules to activate the popup video player.

This popup video player generates a video player window that floats above all other application windows on the computer display screen. The first and second modules may communicate through an application programming interface (API). The first software module may be accessed by the web browser through a network. This network may be the Internet.

The present disclosure includes methods and apparatuses which perform these methods, including processing systems which perform these methods, and computer readable media which when executed on processing systems cause the systems to perform these methods.

Other features of the present invention will be apparent from the accompanying drawings and from the detailed description which follows.

### BRIEF DESCRIPTION OF THE DRAWINGS

The disclosure is illustrated by way of example and not limitation in the figures of the accompanying drawings in which like references indicate similar elements.

FIG. 1 is a screen view of an open Facebook web page displaying a current conventional embedded video player.

FIG. 2 is a screen view of a dynamic floating video player running on top of a conventional window in a display in accordance with the present disclosure.

FIG. 3 is a screen view of a dynamic floating video player running on top of a common email client's software instance in accordance with the present disclosure.

FIG. 4 shows an exemplary overview of a computing system according to one embodiment of the current disclosure.

FIG. 5 is a simplified diagram of a computing device in accordance with the present disclosure.

FIG. 6 displays a screen display according to one embodiment.

FIG. 7 displays a system according to one embodiment.

FIG. 8 displays a flow diagram according to one embodiment.

FIG. 9 shows an exemplary screen display according to one embodiment.

FIG. 10 is a flow diagram of video player operation according to one embodiment.

### DETAILED DESCRIPTION

In the following detailed description of embodiments of the invention, reference is made to the accompanying drawings in which like references indicate similar elements, and in which is shown by way of illustration specific embodiments in which the invention may be practiced. These embodiments are described in sufficient detail to enable those skilled in the art to practice the invention, and it is to be understood that other embodiments may be utilized and that logical, mechanical, electrical, functional, and other changes may be made without departing from the scope of the present invention. The following detailed description is, therefore, not to be taken in a limiting sense, and the scope of the present invention is defined only by the appended claims.

Reference in this specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

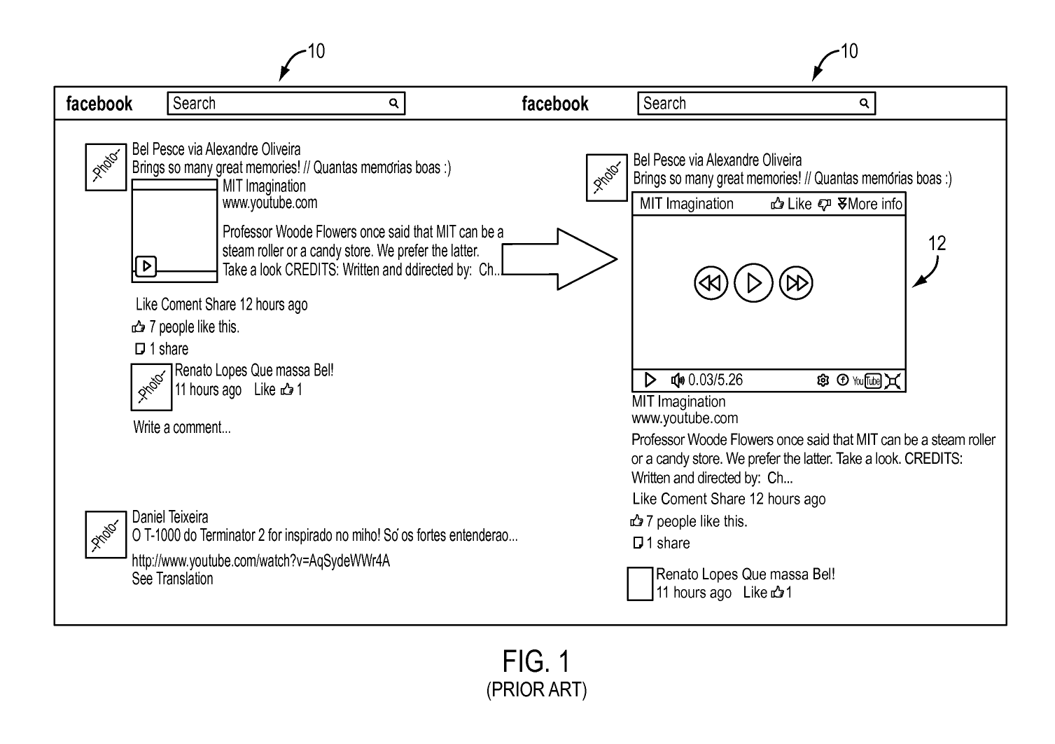

Today the majority of websites have adopted the embedded video player solution (see Google Patent: US 2009/0024923), basically it's possible to see the video inside the current webpage, when the user clicks to play the video, the player expands inside the current page and starts to play. FIG. 1 depicts this behavior. Within the Facebook page 10 the user is provided with the video information such as; video name, description, thumbnail, other information and controls (a button and/or links) that “PLAY” the video. When you click on “PLAY” the players expands and video is played in the window 12 within the same page.

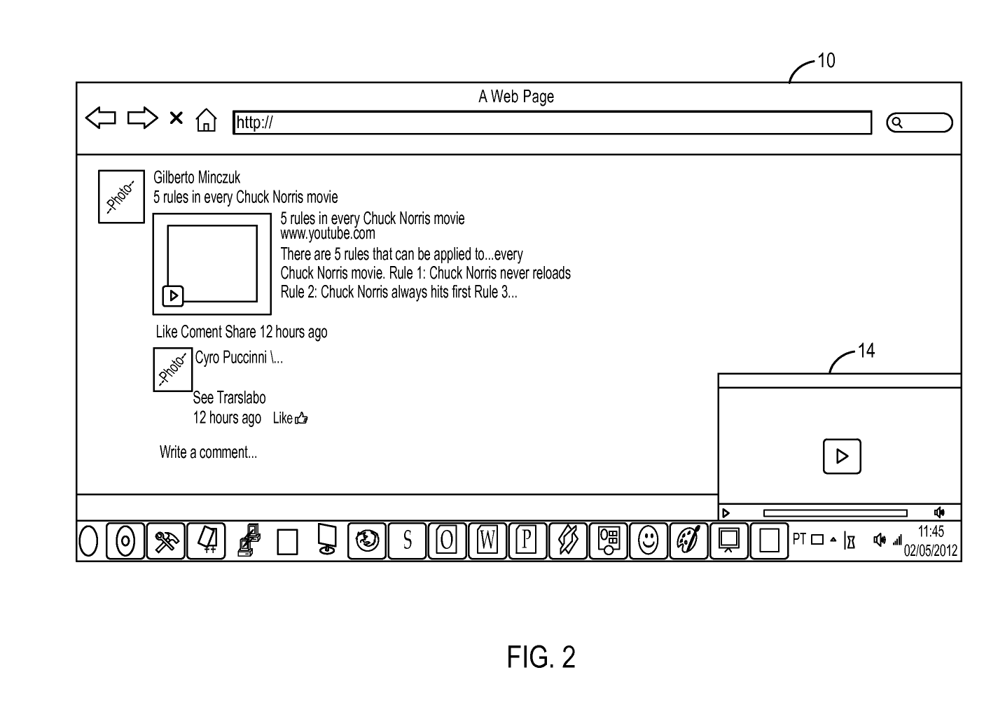

The present disclosure involves use of a decidedly new approach that provides a new experience and behavior when a user clicks to play a video in a webpage 10. In a Dynamic Floating Video Player in accordance with the present disclosure, when you click on “PLAY video” the webpage starts and communicates with a standalone application that launches a small Dynamic Floating Video Player in one corner of the user's screen. FIG. 2 is a screen shot of one exemplary Dynamic Floating Video Player 14. This makes it possible for the user to watch the video; while, performing others task on the computer such as; browsing on the web, checking emails, writing a document, etc. Our method and system establishes a line of communication between the webpage 10 and the Dynamic Floating Video Player 14. It is possible to control the Dynamic Floating Video Player 14 with controls inside the webpage. For example, the user can change the video, pause, play, control the volume and access any other kind of video control inside the page. These actions will be executed within the Dynamic Floating Video Player 14. In this manner, the webpage 10 acts like a remote control for the Dynamic Floating Video Player 14.

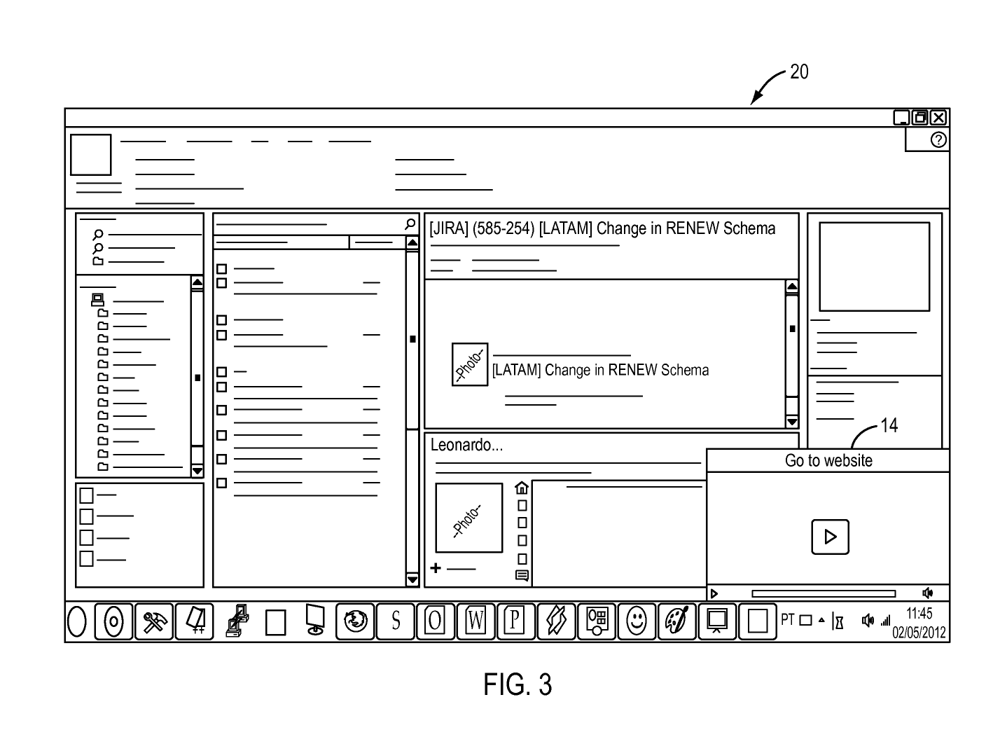

The Dynamic Floating Video Player 14 is generated by a piece of software that floats above all other application windows. It's possible to browse the web and access other web pages, open other applications change the current window, etc. and the Dynamic Floating Video Player remains open and visible. In FIG. 3 you see the same Floating Video Player 14 running above a common email client's software 20.

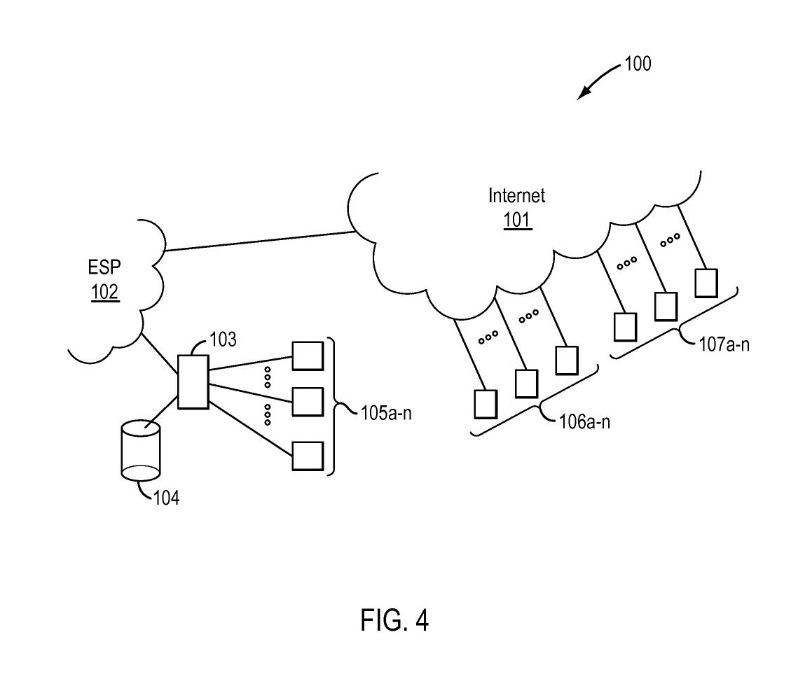

FIG. 4 shows an exemplary system 100 according to one embodiment of the current disclosure. An electronic services portal (ESP) 102 connects to a server 103 and to one or more data repositories 104. The server hosts software instances 105a-n of the present disclosure, plus basic elements of the overall system, such as the operating system, as well as any other inherently needed or present software, which, depending on the implementation of the system, may be one, several, or many instances. These software instances are to be considered only exemplary indications of how the software could be installed in server 103 and how it could work in conjunction with ESP 102, Personal Information Managers (PIMs, not shown) or smart phones, and main data repository 104. System 102 connects via Internet 101 to system users 106a-n and service providers 107a-n. It is clear that these connections could also be made through a direct connection, through a phone system, or through any other suitable networking method, known or to be invented.

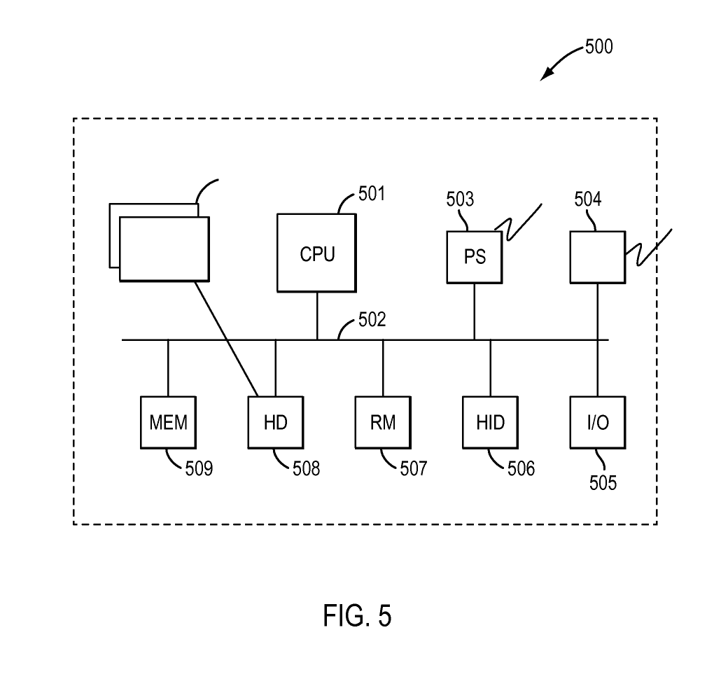

FIG. 5 shows a simplified architectural diagram of an exemplary computer such as the server 500. Server 500 contains a CPU 501; a system bus 502; power supply unit 503; network interface 504; input/output (I/O) unit 505; a human interface device 506, which may or may not be present; removable media drive 507, which may be used to load software into the computer; hard drive 508, on which the software may be installed; and memory 509, which may include both RAM and nonvolatile memory for software such as a basic input output system (BIOS) and other system software, such as an operating system, for example Microsoft® Windows®, Linux®, or any other, similar suitable software. It is clear that in a networked environment many of these elements could be moved to one or more other computer(s) and could communicate over a network (as connected to by network interface 504, for example, typically an Ethernet or similar type of network) with system 100, but, essentially, all these elements together are required to properly operate a computer and to run the software instances 105a-n, which are typically installed on the hard drive, even if the hard drive is not a local hard drive.

The processes described above can be stored in a memory of a computer system as a set of instructions to be executed. In addition, the instructions to perform the processes described above could alternatively be stored on other forms of machine-readable media, including magnetic and optical disks. For example, the processes described could be stored on machine-readable media, such as magnetic disks or optical disks, which are accessible via a disk drive (or computer-readable medium drive). Further, the instructions can be downloaded into a computing device over a data network in a form of compiled and linked version.

The dynamic floating video player applet may be stored in a database that is accessible via the Internet by any number of computer users. When first called, the applet may be retrieved and downloaded to a user's computing device and thence stored in the user's computing device for future use on an as needed basis.

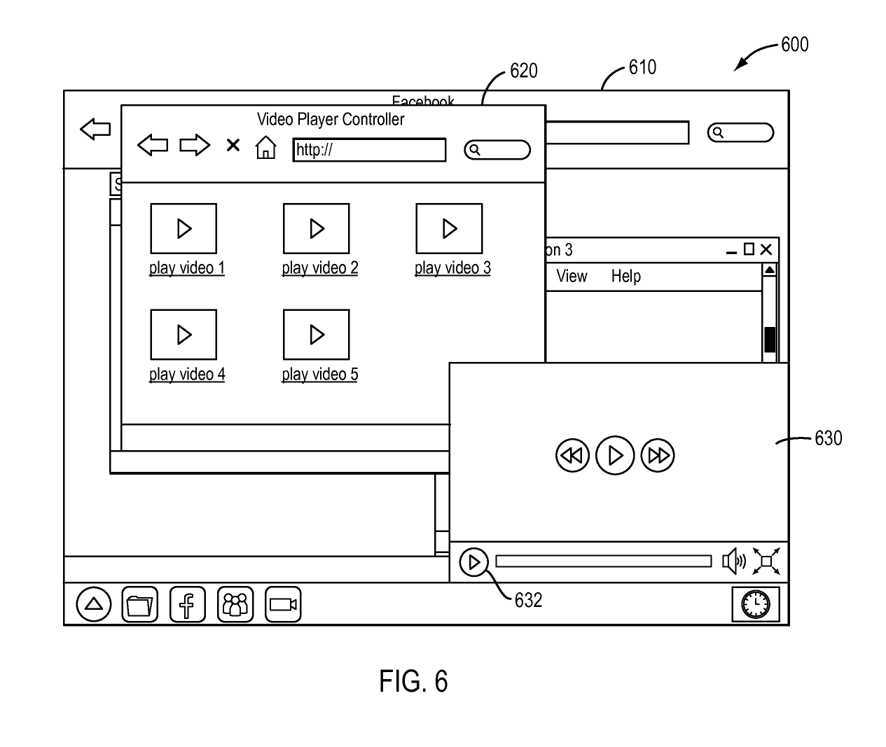

A computer display screen 600 is shown in FIG. 6. On the screen 600 is displayed a window, for example, displaying a Facebook page 610. A user has activated the dynamic video player in accordance with the present disclosure by clicking on its icon in the Facebook page 610. A video player controller window 620 is displayed on top of the Facebook page 610. When the user selects one of the videos numbered 1-5, a control window 630 appears which shows the basic controls for the selected video. When the forward icon 632 is clicked on, the video player begins to play and the icon 632 changes to a pause icon.

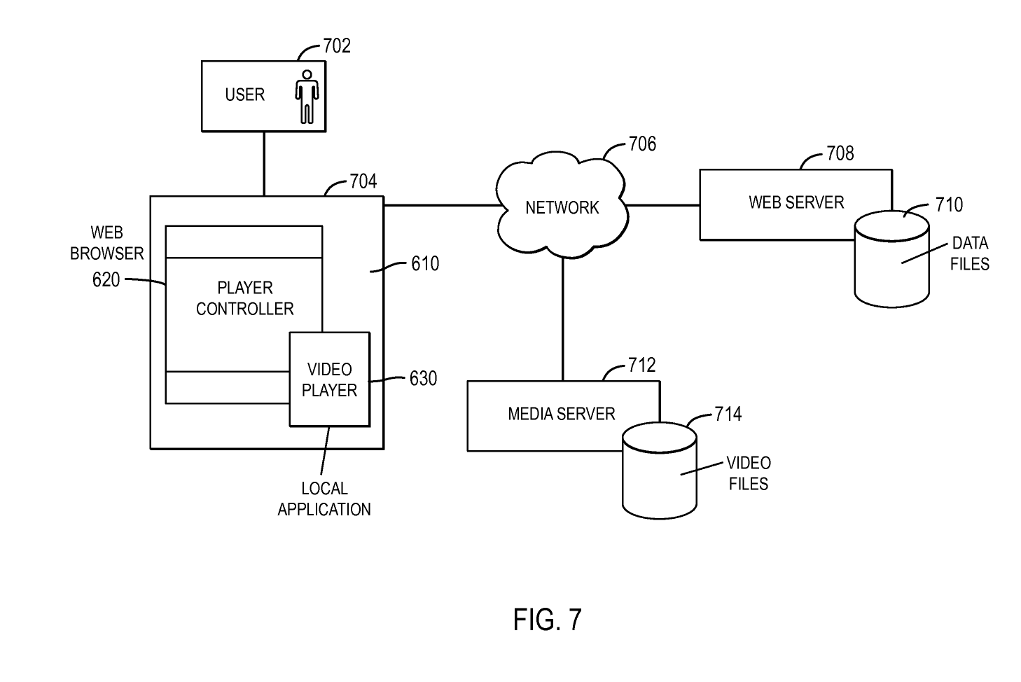

An exemplary system 700 is shown in FIG. 7. A computing device 704 operated by a user 702 connects through a network 706 such as the Internet to a web server 708. The web server 708, in turn, communicates with a storage device 710 containing data files and software applications. In addition, the computing device 704 may communicate through the network 706 to a media server 712 that has access to a video file storage device 714. The computing device 704 includes a processor communicating with a memory and a display device for displaying a web page such as web page 610 shown in FIG. 6. The web browser in turn displays a player controller window 620. When clicked on, the player controller displays a video player window 630 via a local application on the computing device 704 as described above.

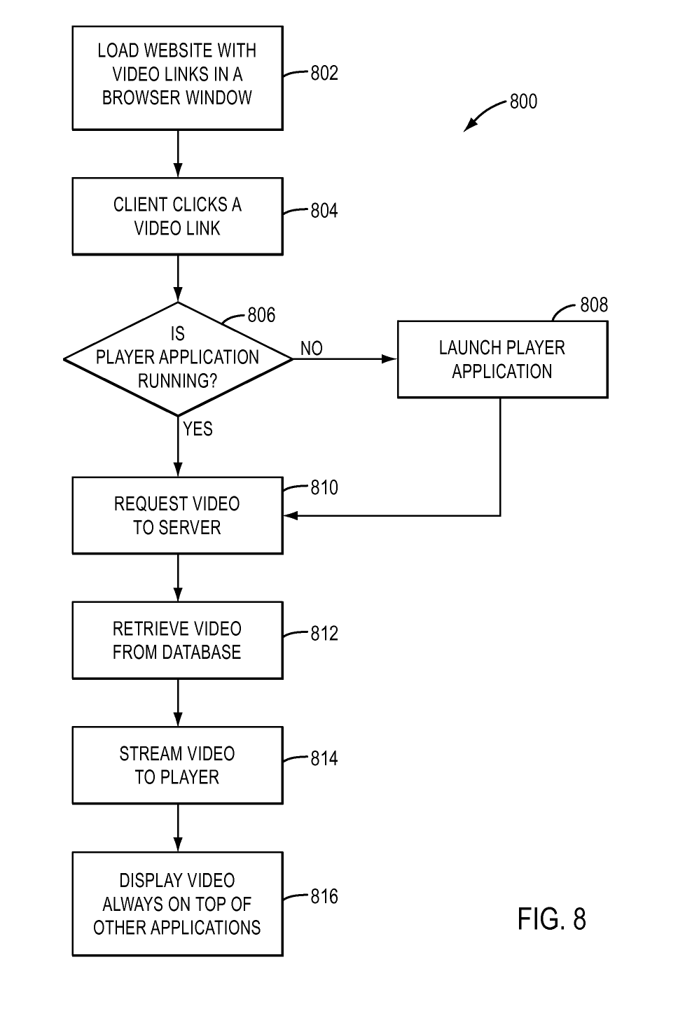

FIG. 8 is a process flow diagram 800 for one embodiment of a player in accordance with the present disclosure. In operation 802 a user 702 causes the computing device 704 to load a website page, such as a Facebook page, that has video links in a browser window. One example is the video player controller window 620 shown in FIG. 6. Control then transfers to operation 804. In operation 804, the user (Client) clicks on one of the video links in order to send instructions via the computing vice 702 to access a selected video. Control then transfers to query operation 806.

Query operation 806 asks whether a player application is currently running. If not, control transfers to operation 808. In operation 808, the computing device 702 communicates with the media server 712 and/or the web server 708 to obtain and launch the video player application in accordance with the present disclosure in the computing device 702. Once the video player application is launched, control transfers to operation 810.

On the other hand, if, in query operation 806, it is determined that the player application is currently running on the computing device 702, control transfers directly to operation 810. In operation 810, the selected video to be played is requested from the media server 712. The media server in turn retrieves the requested video from the media database 714 in operation 812. Control then transfers to operation 814.

In operation 814, the requested video is streamed or otherwise transferred or downloaded to the computing device 712 and directed to the video player application. Control then transfers to video player operation 816 for display in the video player window 630. In operation 816, the video player window 630 is displayed always on top of other applications that are being displayed on the display screen 610 by virtue of the communication between the player and browser modules described below.

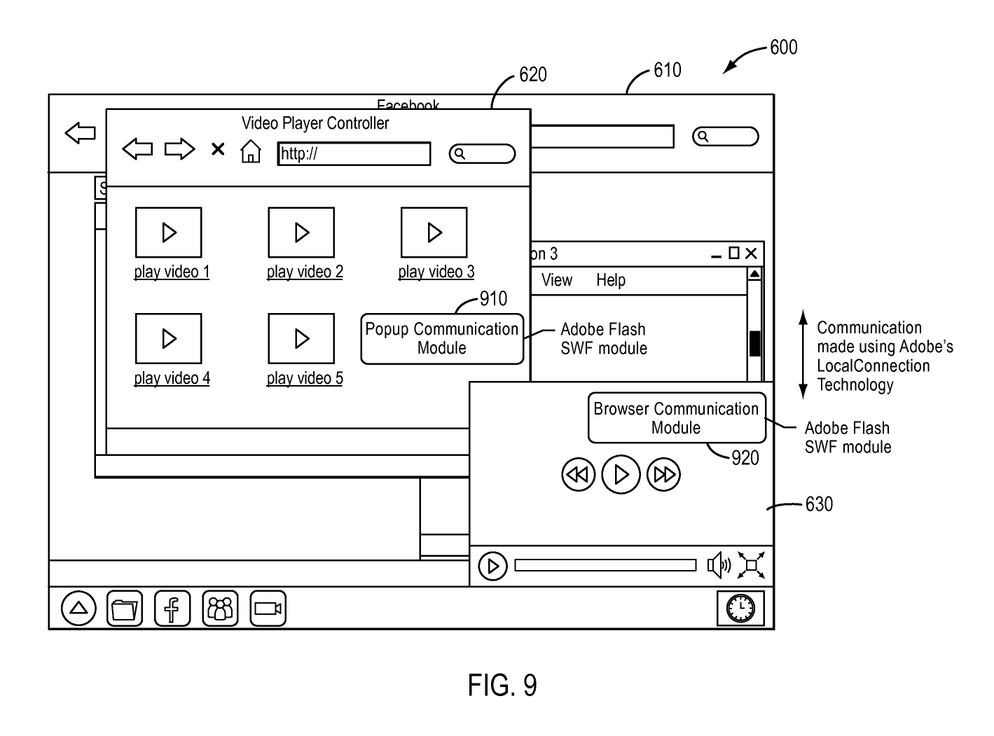

A display of the software applet instances on the display 600 is shown in FIG. 9. The video player controller 620 is embedded in a popup communication module 910 that is loaded onto the computing device 704 and is operated by the computing device operating system. In one example, this popup communication module may be an Adobe Flash Shockwave Flash (SWF) file module.

The video player controller 620 in this example is resident in the web page operated by the web browser in the computing device operating system. This controller 620 includes a popup communication module 910. This exemplary module 910 is an Adobe Flash SWF module. The popup video player 630 includes a browser communication module 910. This exemplary browser communication module 920 is another Adobe flash SWF module 920 which communicates with the module 910 using Adobe's “Local Connection” technology.

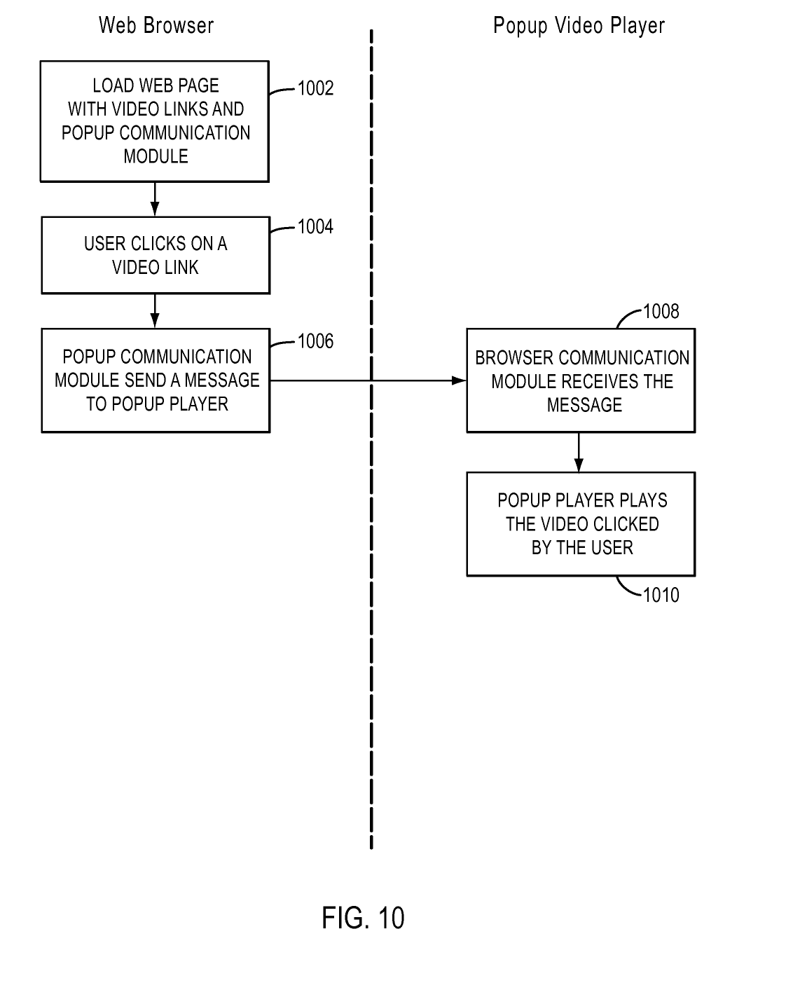

A flow diagram of video player operation is shown in FIG. 10 showing the operations on the web browser side and the popup video player side. On the web browser side, the web page with video links and popup communication module is loaded into the web browser in operation 1002. Next, in operation 1004, a user clicks on a video link displayed in the video controller window 620 shown in FIG. 9. When this happens, the popup communication module 910 sends a call message in operation 1006 to the popup player 630. The browser communication module 920 receives the message on the popup video player side in operation 1008. The browser communication module 920 then plays the video called in the popup video player 630 in operation 1010.

Alternatively, the logic to perform the processes as discussed above could be implemented in additional computer and/or machine readable media, such as discrete hardware components as large-scale integrated circuits (LSIs), application-specific integrated circuits (ASICs), and firmware such as electrically erasable programmable read-only memory (EEPROMs).

It is clear that many modifications and variations of this embodiment may be made by one skilled in the art without departing from the spirit of the novel art of this disclosure. These modifications and variations do not depart from the broader spirit and scope of the invention, and the examples cited here are to be regarded in an illustrative rather than a restrictive sense.

What is claimed is:

1. A computer-implemented method comprising:
providing a computing device connected to a network, the device having a processor, a memory connected to the processor, and a computer display screen;
embedding a first software module in a web page capable of displayed on the screen by a web browser operating in the computing device;
embedding a second module in a popup video player application running in a different application from the web browser; and
sending a message between the first and second modules to activate the popup video player wherein the popup video player generates a video player window that floats above all other application windows on the computer display screen.

2. The computer-implemented method of claim 1, wherein the first and second modules communicate through an application programming interface (API).

3. The computer-implemented method of claim 1, wherein the first software module is accessed by the web browser through a network.

4. The computer-implemented method of claim 3, wherein the network is the Internet.

5. The computer-implemented method of claim 1, wherein the first and second modules are each Shockwave Flash (SWF) files.

6. A tangible nonvolatile machine readable medium having stored thereon a set of instructions which when executed in a computing device having a processor, a memory connected to the processor, and a computer display screen, wherein the device is connected to a network, the device performing a method comprising:
embedding a first software module in a web page capable of displayed on the screen by a web browser operating in the computing device;
embedding a second module in a popup video player application running in a different application from the web browser; and
sending a message between the first and second modules to activate the popup video player wherein the popup video player generates a video player window that floats above all other application windows on the computer display screen.

7. The tangible nonvolatile machine readable medium of claim 6, wherein the first and second modules communicate through an application programming interface (API).

8. The tangible nonvolatile machine readable medium of claim 6, wherein the first software module is accessed by the web browser through a network.

9. The tangible nonvolatile machine readable medium of claim 8, wherein the network is the Internet.

10. The tangible nonvolatile machine readable medium of claim 6, wherein the first and second modules are each Shockwave Flash (SWF) files.

11. A system comprising:
a computing device connected to a network, the device having a processor, a memory connected to the processor, and a computer display screen;
a first software module embedded in a web page capable of being displayed on the screen by a web browser operating in the computing device;
a second module embedded in a popup video player application running in a different application from the web browser;
wherein the web browser is operable to send a message between the first and second modules to activate the popup video player application to generate a video player window that floats above all other application windows on the computer display screen.

12. The system of claim 11, wherein the first and second modules communicate through an application programming interface (API).

13. The system of claim 11, wherein the first software module is accessed by the web browser through a network.

14. The system of claim 13, wherein the network is the Internet.

15. The system of claim 11, wherein the first and second modules are each Shockwave Flash files.
